(19) United States
(12) Patent Application Publication
(10) Pub. No.: US 2024/0173831 A1
(43) Pub. Date: May 30, 2024

(54) CIRCLIP PLIERS WITH GRIPPING SURFACES

(71) Applicant: Apex Brands, Inc., Apex, NC (US)

(72) Inventors: Jesse Higgins, Raleigh, NC (US); Eric Van Fossen, Huntersville, NC (US); Zhihong Fu, Cary, NC (US); Kyle Romanick, Fuquay Varina, NC (US)

(21) Appl. No.: 18/502,230

(22) Filed: Nov. 6, 2023

Related U.S. Application Data
(60) Provisional application No. 63/428,834, filed on Nov. 30, 2022.

(51) Int. Cl. B25B 27/20

(52) U.S. Cl. CPC B25B 27/205

(57) ABSTRACT

A hand tool may include a head section which may include a top jaw and a bottom jaw, a handle section which may include a top handle and a bottom handle, a joint assembly which may operably couple the head section to the handle section, a pin assembly which may include a first pin disposed at a distal end of the top jaw and a second pin disposed at a distal end of the bottom jaw, and a gripping assembly which may include a first gripping surface disposed at the top jaw proximate to the first pin and a second gripping surface disposed at the bottom jaw proximate to the second pin. The first and second gripping surfaces may grip objects therebetween responsive to the top jaw and the bottom jaw moving towards each other.

### CROSS REFERENCE TO RELATED APPLICATION

This application claims priority to U.S. provisional application No. 63/428,834 filed Nov. 30, 2022, the entire contents of which are incorporated herein by reference.

### TECHNICAL FIELD

Example embodiments generally relate to hand tools and, in particular, relate to solid joint circlip pliers.

### BACKGROUND

Hand tools are commonly used across all aspects of industry and in the homes of consumers. Hand tools are employed for multiple applications including, for example, tightening, component joining and/or the like. For some component joining applications, a solid joint pliers (e.g., a pliers that does not have a slip joint, tongue-and-groove, channel lock, or other adjustable joint) may be preferred. In some cases, solid joint pliers may be adapted for specific use with circlips in applications where other components may be retained on shafts or housings of various types. In this regard, pliers may be used to either contract or expand circlips to depending on whether the circlip is externally applied or internally applied.

Often referred to as circlip pliers, retaining ring pliers, or snap ring pliers, typical circlip pliers operably couple to a circlip to allow for the pliers to either expand or contract the circlip in order to effectively apply the circlip in a desired position. Many circlips are formed as open-ended rings, rather than being one continuous and intact circle. Proximate to the open end, some circlips may include an orifice disposed on either side of the open end to which the circlip pliers may operably couple. Thus, using the open end, the circlip may rely on spring tension to retain their natural shape, and in order to apply a force to either expand or contract the circlip, the circlip pliers may operably couple to the orifices. Typically, the region between the jaws of typical circlip pliers may be unused since most circlip pliers may be designed to operably couple with circlips exclusively via a structure that interacts with the orifices of the circlip.

Thus, it may be desirable to develop an improved design for circlip pliers so that the circlip pliers may be used to grip objects via alternative methods.

### BRIEF SUMMARY OF SOME EXAMPLES

Some example embodiments may provide for a hand tool. The hand tool may include a head section which may include a top jaw and a bottom jaw, a handle section which may include a top handle and a bottom handle, a joint assembly which may operably couple the head section to the handle section, a pin assembly which may include a first pin disposed at a distal end of the top jaw and a second pin disposed at a distal end of the bottom jaw, and a gripping assembly which may include a first gripping surface disposed at the top jaw proximate to the first pin and a second gripping surface disposed at the bottom jaw proximate to the second pin. The first and second gripping surfaces may grip objects therebetween responsive to the top jaw and the bottom jaw moving towards each other.

Some example embodiments may provide for a dual function hand tool. The dual function hand tool may include a head section which may include a top jaw and a bottom jaw, a handle section which may include a top handle and a bottom handle, a joint assembly which may operably couple the head section to the handle section, a pin assembly which may include a first pin disposed at a distal end of the top jaw and a second pin disposed at a distal end of the bottom jaw, and a gripping assembly which may include a first gripping surface disposed at the top jaw proximate to the first pin and a second gripping surface disposed at the bottom jaw proximate to the second pin. The dual function hand tool may operably couple with a circlip via the pin assembly and may grip objects with the gripping assembly.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a perspective view of a hand tool according to an example embodiment;

FIG. 2 is a close-up perspective view of the top jaw of the hand tool in accordance with an example embodiment;

FIG. 3 is a close-up perspective view of the bottom jaw of the hand tool in accordance with an example embodiment;

FIG. 4 is a close-up side profile view of the bottom jaw of the hand tool in accordance with an example embodiment;

FIG. 5 is a close-up top view of the bottom jaw of the hand tool in accordance with an example embodiment;

FIG. 6 depicts a close-up side view of the gripping assembly and the pin assembly in accordance with an example embodiment;

FIG. 7 is a close-up section view of the second gripping surface and the bore in accordance with an example embodiment; and

FIG. 8 is a close-up top view of the first gripping surface in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

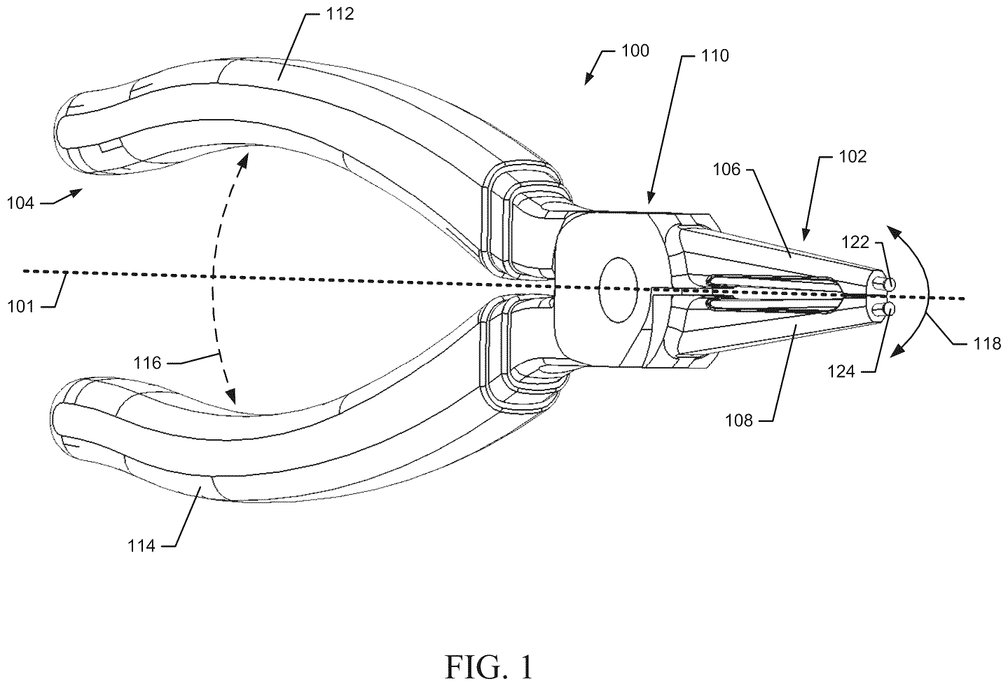

As indicated above, some example embodiments may relate to the provision of circlip pliers that employ an improved design. Of note, the hand tool 100 of FIG. 1 should be understood to be positioned such that it can be bisected by a vertically oriented plane that passes through the longitudinal centerline 101 of the hand tool 100. The terms “top,” “bottom,” “right,” and “left” should therefore be understood as relative terms that are applicable to this particular orientation. To the extent the terms “front” and “back” are also used, the front of the hand tool 100 should be understood to be the working end thereof (i.e., the end at which the jaws are located), and the back of the hand tool 100 is the opposite end to the working end (i.e., the end at which the handles are located).

Referring now to FIG. 1, the hand tool 100 may include a head section 102 and a handle section 104. The head section 102 may include a top jaw 106 and a bottom jaw 108. The head section 102 may be separated from the handle section 104 by the joint assembly 110. The handle section 104 may include a top handle 112 and a bottom handle 114. A pin assembly 120 may be disposed at a distal end of the head section 102 at the front of the hand tool 100. In this regard, the top jaw 106 and the bottom jaw 108 may each include a bore 115 disposed at the distal end of each jaw (106, 108) that extends into the respective jaw towards the joint assembly 110. In some cases, the hand tool 100 may include a gripping assembly 130 which may include a first gripping surface 132 disposed at the top jaw 106 and a second gripping surface 134 disposed at the bottom jaw 108. The first and second gripping surfaces (132, 134) may be formed so that when the top jaw 106 is proximate to the bottom jaw 108, the first gripping surface 132 may interface with the second gripping surface 134. In some cases, each gripping surface (132, 134) may extend a distance substantially equal to the depth of the bore 115 in each of the top and bottom jaws (106, 108).

The pin assembly 120 may include a first pin 122 disposed in the bore 115 of the top jaw 106, and a second pin 124 disposed in the bore 115 of the bottom jaw 108. The first and second pins (122, 124) of the pin assembly 120 may extend out of their respective bores 115, and away from their respective jaws in which the first and second pins (122, 124) are disposed. In this regard, the hand tool 100 may operably couple to a circlip (i.e., a retaining ring) and thus may apply a force to the circlip to contract the circlip to fit in a desired location via the pin assembly 120. As such, in some cases, the circlip may include first and second orifices that may correspond to the first and second pins (122, 124) of the pin assembly 120. Responsive to the first and second pins (122, 124) operably coupling to the first and second orifices, the hand tool 100 may be used to apply a force to the circlip to contract the circlip to fit the circlip in the desired location. In some embodiments, the top and bottom jaws (106, 108) may not include respective bores 115, and thus the pin assembly 120 may not be disposed in the bores 115. In this regard, the pin assembly 120 may be integrally formed from the material of the top and bottom jaws (106, 108). In other words, the top and bottom jaws (106, 108) may be machined to remove some material at the distal end of each of the top and bottom jaws (106, 108) to form the first and second tips (122, 124), respectively. Despite the manner in which the pin assembly 120 is operably coupled to the top and bottom jaws (106, 108), the pin assembly 120 may be capable of performing the same essential functions described below.

FIG. 1 depicts an embodiment where the hand tool 100 may be a set of internal circlip pliers. In this embodiment, the top jaw 106 and bottom handle 114 may be formed of a rigid metallic material (e.g., iron or steel, such as induction hardened steel) and the bottom jaw 108 and top handle 112 may be similarly formed of a rigid metallic material (e.g., the same material used to form the top jaw 106 and bottom handle 114). The single unitary piece comprising the top jaw 106 and bottom handle 114 may transition between the top jaw 106 and the bottom handle 114 at a transition portion that may be located at the joint assembly 110. Likewise, the single unitary piece comprising the bottom jaw 108 and top handle 112 may similarly transition between the bottom jaw 108 and the top handle 112 at a transition portion that may be located at the joint assembly 110. In this regard, the joint assembly 110 may be where the two unitary pieces of the hand tool 100 are pivotably operably coupled to each other to allow for the operation of the hand tool 100. In an example embodiment, at least some of the metallic portions of the hand tool 100 may be covered with a corrosion resistant finish (e.g., a black-oxide finish). Lengths of the top jaw 106, top handle 112, bottom jaw 108, bottom handle 114, first pin 122 and second pin 124 may be selected to provide any desirable length for the hand tool 100.

In comparison to external circlip pliers, internal circlip pliers may contract the internal circlip in order to place the circlip in the desired location. In some embodiments, for example, an internal circlip may be used to hold objects in place inside a tube, and as such, the internal circlip may need to be contracted to fit inside the tube and then released to secure itself to the interior of the tube. In this regard, the internal circlip may rely on a spring force to operably couple to the desired location, such as on the interior of the tube. Thus, in a pair of internal circlip pliers, separating the top handle 112 from the bottom handle 114 (i.e., by moving them in the direction shown by arrow 116) may pivot the top jaw 106 away from the bottom jaw 108 (i.e., in the direction shown by arrow 118), which thereby moves the first pin 122 away from the second pin 124. Then, responsive to the top handle 112 being compressed back towards the bottom handle 114, the opposite motions may occur, and the first pin 122 may move back towards the second pin 124. Accordingly, the internal circlip pliers may apply a force on the circlip to contract the internal circlip to be placed in the desired location responsive to the top handle 112 being compressed back towards the bottom handle 114.

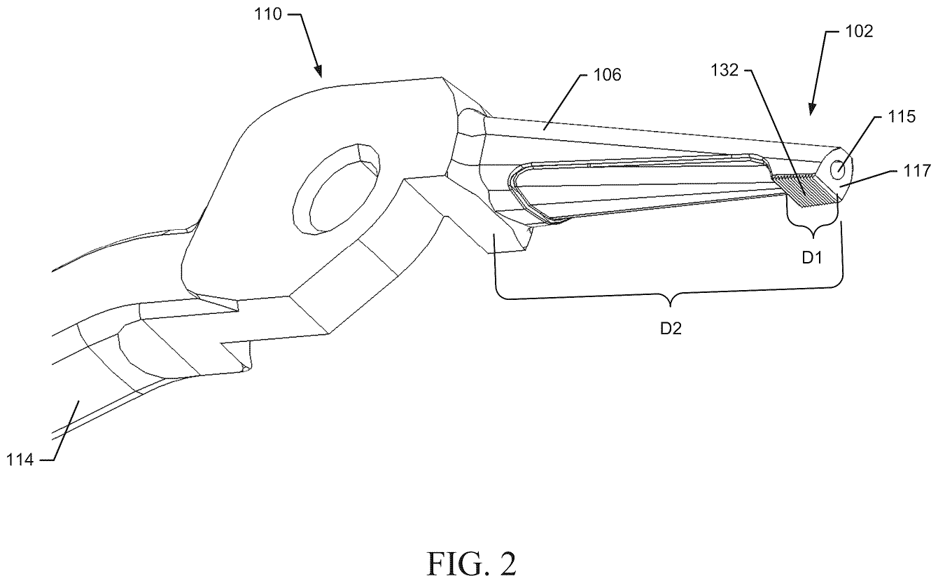

FIGS. 2-8 depict various views of portions of the hand tool 100 according to an example embodiment. Among the components shown in FIGS. 2-8, the gripping assembly 130 may often be visible. As described above, the gripping assembly 130 may include the first gripping surface 132 disposed at the top jaw 106, proximate to the first pin 122, and the second gripping surface 134 disposed at the bottom jaw 108, proximate to the second pin 124. The gripping assembly 130 may be disposed on respective inner-facing surfaces of the top and bottom jaws (106, 108) so that the hand tool 100 may grip objects between the top and bottom jaws (106, 108) via the gripping assembly 130, responsive to the top jaw 106 and the bottom jaw 108 moving towards each other.

The inclusion of the gripping assembly 130 in the hand tool 100 may be especially noteworthy in the case where the hand tool 100 described herein may be embodied as circlip pliers. In this regard, known circlip pliers are often designed to only operably couple with circlips via a circlip-specific structure (e.g., the pin assembly 120) that operably couples to the orifices disposed at the circlip in order to place the circlip in the desired location. Accordingly, known circlip pliers do not have a need for, and thus do not include, the gripping assembly 130 as part of the hand tool 100. In fact, in most cases, the mere existence of the circlip-specific structure (e.g., the pin assembly 120) that operably couples to the orifices of the circlip often suggests that the circlip pliers would not also include the gripping assembly 130 and thus would not be used to grip objects between the top and bottom jaws (106, 108). In this regard, in examples embodiments of known circlip pliers, the distal end of the jaws where they contact one another may end up as unused and/or dead space by not including the gripping assembly 130. In such cases, an operator of previously known circlip pliers may often need to have another set of pliers on-hand that they may utilize to grip objects as required by their work. For example, if the operator were to be installing the circlip in the desired location and the circlip were to become removed from its operable coupling with the existing circlip pliers, the operator would then have to utilize another set of pliers, such as needle nose pliers, to grip and retrieve the circlip. Therefore, among other solutions, the present invention may provide a solution the problem of needing separate tools for various work scenarios by implementing the gripping assembly 130 onto the hand tool 100 at the distal end of the top and bottom jaws (106, 108). Accordingly, the hand tool 100 may be a dual function tool that may operably couple with a circlip via the pin assembly 120 and may grip objects with the gripping assembly 130.

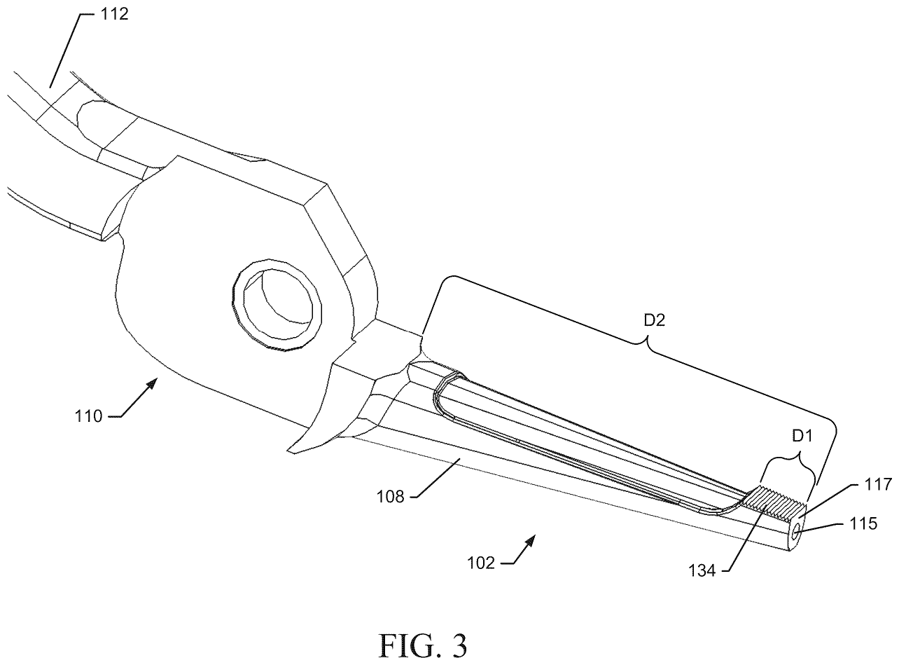

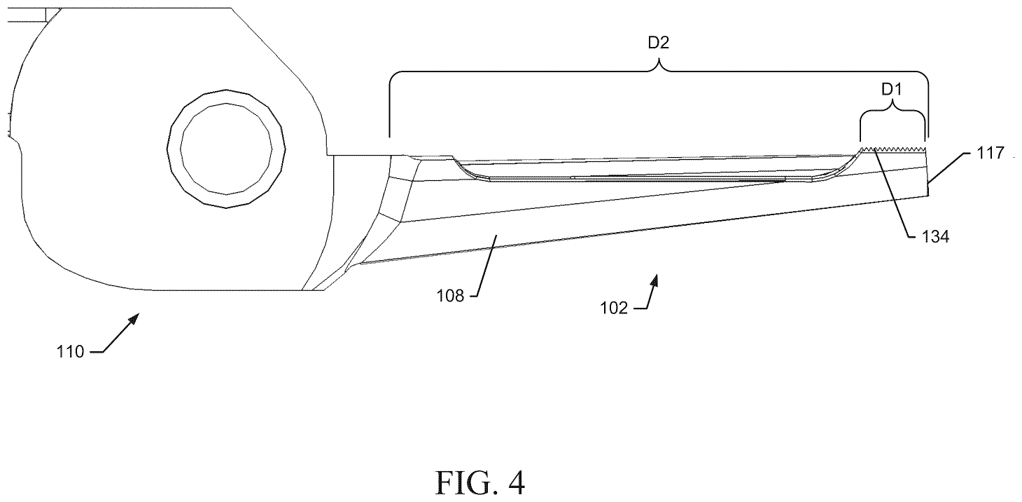

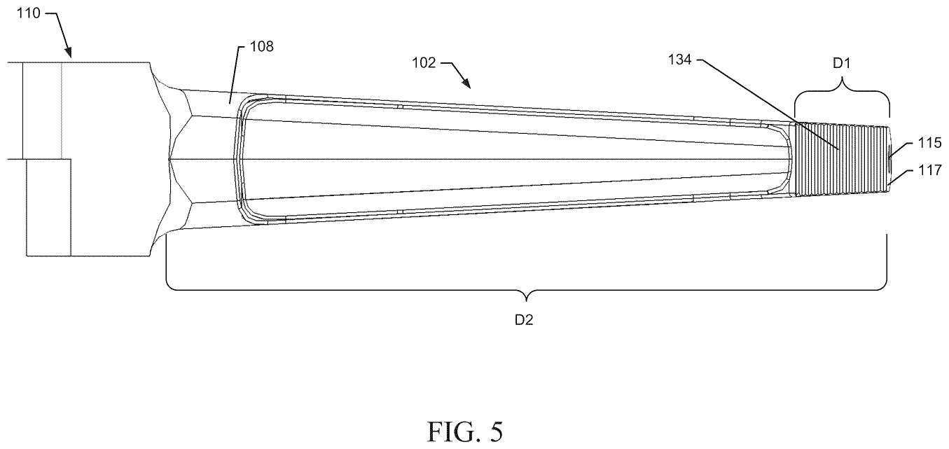

FIGS. 2 and 3 depict perspective views of the top and bottom jaws (106, 108), respectively, and FIGS. 4 and 5 depict side profile and top views of the bottom jaw 108, respectively, according to an example embodiment. As described above, the joint assembly 110 may pivotably operable couple each unitary member of the hand tool 100 together, so that the relative motion between the top handle 112 and the bottom handle 114 results in the relative motion between the top jaw 106 and the bottom jaw 108. As shown in FIGS. 2-5, the first gripping surface 132 and the second gripping surface 134 may be disposed at a distal end of the respective jaws (106, 108) proximate to the pin assembly 120. The first and second gripping surfaces (132, 134) may extend from the distal end of the respective jaws (106, 108) towards the joint assembly 110 with a length (D1) that may be roughly equal to 10% of a length (D2) of the top and bottom jaws (106, 108), respectively. In some embodiments, the first and second gripping surfaces (132, 134) may each comprise teeth 140. The teeth 140 may enhance the ability of the gripping assembly 130 to grip objects by providing more surfaces and more surface area for the gripping assembly 130 to engage with various objects. As shown in FIGS. 4 and 5, the top and bottom jaws (106, 108) may both taper as they extend from the joint assembly 110 towards the pin assembly 120. However, rather than form a point at the distal end thereof, each jaw (106, 108) may include a planar surface 117 disposed at the end of each of the top and bottom jaws (106, 108).

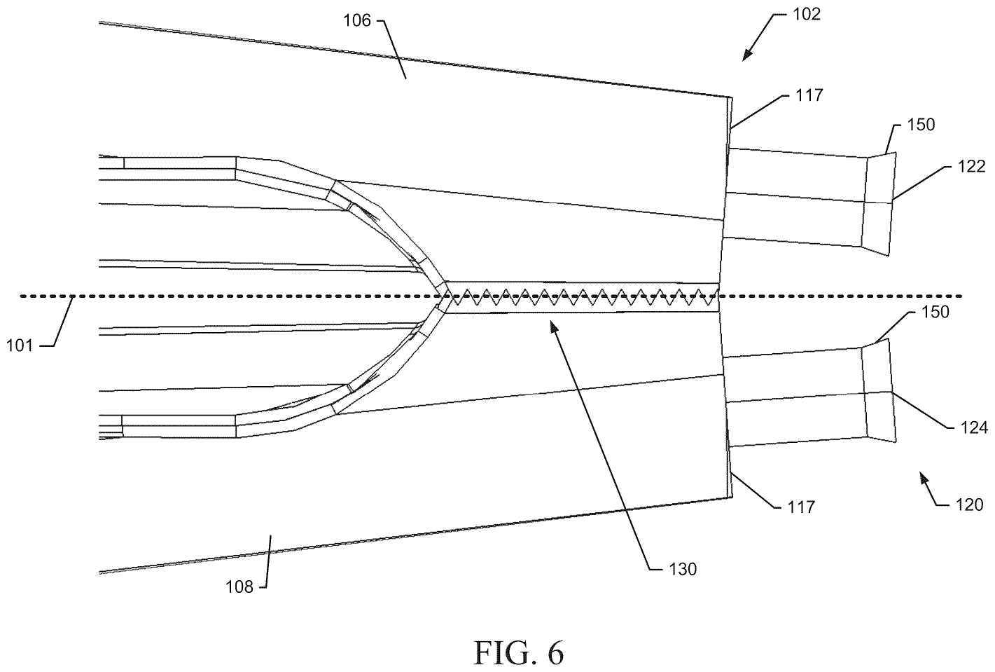

FIG. 6 depicts a close-up view of the gripping assembly 130 and the pin assembly 120 according to an example embodiment. As shown in FIG. 6, the teeth 140 of the first gripping surface 132 may interlace with the teeth 140 of the second gripping surface 134 when the top jaw 106 may be proximate to the bottom jaw 108. According to an example embodiment, the teeth 140 of the first and second gripping surfaces (132, 134) may interlace along the longitudinal centerline 101 of the hand tool 100. In this regard, the first and second gripping surfaces (132, 134) may be parallel with the longitudinal centerline 101 when the hand tool 100 is in a closed state, as depicted in FIG. 6. At the same time, the first and second gripping surfaces (132, 134) may not be parallel with the respective bores 115 within the top and bottom jaws (106, 108) nor with the first and second pins (122, 124) of the pin assembly 120 disposed within the bores 115. In this regard, in some embodiments, the distal end of the top and bottom jaws (106, 108) may include a planar surface 117 at the tip rather than the jaws (106, 108) forming a point. As shown in FIG. 6, the planar surfaces 117 at the top and bottom jaws (106, 108), respectively, may not be coplanar with one another. In other words, the end of the top and bottom jaws (106, 108) may each be planar, but they may not both lie in the same plane as the other. Thus, when viewed from the side, such as in FIG. 6, the top and bottom jaws (106, 108) may appear to form a widened “V” shape at the distal end of the head section 102 with the hand tool in the closed state.

The pin assembly 120 depicted in FIG. 6 may include first and second pins (122, 124) that may be substantially cylindrical in shape. The substantially cylindrical pins (122, 124) may operably couple to the orifices of the circlip by being inserted into the orifices of the circlip. Thus, the pin assembly 120 may directly interact with the circlip via the curved surface of the substantially cylindrical pins (122, 124). However, in some embodiments, the pin assembly 120 may be shaped in a variety of ways in order to maximize the ease and security of the operable coupling between the pin assembly 120 and the circlip. For example, the pins (122, 124) may be conical, frustoconical, or tapered. In this regard, the conical, frustoconical or tapered shaped may make it easier to insert the first and second pins (122, 124) into the orifices of the circlip. The farther that the pins (122, 124) are inserted into the circlip orifices, the more secure the operable coupling between the pin assembly 120 and the circlip may be, due to the angled shape of the pin assembly 120 and the increased friction force on the circlip as a result of the shape of the pin assembly 120.

In some cases, the pin assembly 120 may include a circlip retention lip 150 disposed at a distal end of the first and second pins (122, 124). The circlip retention lip 150 may increase the cross sectional area of the first and second pins (122, 124) so that the pin assembly 120 is more likely to remain operably coupled to the circlip when the hand tool 100 is in use. In this regard, as shown in FIG. 6, the circlip retention lip 150 may angularly extend from the distal end of the first and second pins (122, 124) such that the distal end of the first and second pins (122, 124) appears to have an inverted frustoconical shape that makes the first and second pins (122, 124) wider at the distal end thereof. Similarly, in other embodiments, the pin assembly 120 may include a circlip retention lip 150 that may be flared rather than angular. In this regard, the flared circlip retention lip 150 may add a radius of curvature to the angle formed between the length of the first and second pins (122, 124) and an end surface of the first and second pins (122, 124).

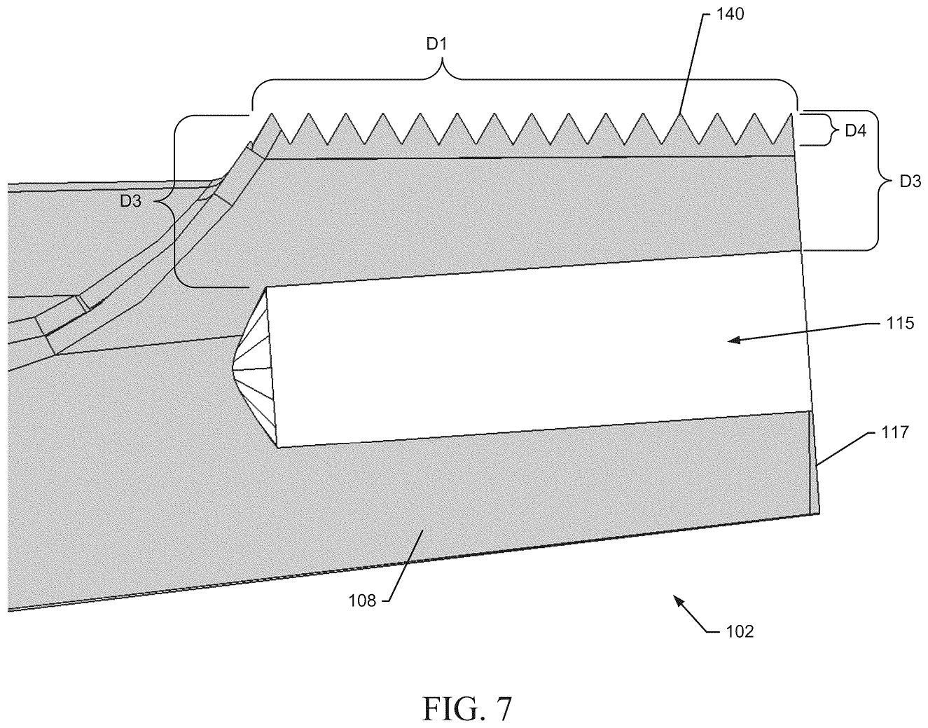

FIG. 7 depicts a close-up section view of the second gripping surface 134 and the bore 115 of the bottom jaw 108 according to an example embodiment. The gray shaded regions of FIG. 7 may be indicative of solid material of the bottom jaw 108 that has been sectioned through in order to visualize the bore 115 and the teeth 140. As shown in FIG. 7, the bore 115 may be formed within the top and bottom jaws (106, 108) and extend in a direction normal to the planar surface 117 at the tip of the respective jaws (106, 108) so that the first and second pins (122, 124) that may be disposed within the bores 115 may also extend normal to the planar surface 117 at the tip of the top and bottom jaws (106, 108). In this regard, a distance (D3) between the first and second gripping surfaces (132, 134) and the bores 115 for the first and second pins (122, 124), respectively, may be within a range of roughly 3 to 4 times a depth (D4) of the teeth 140 measured from the tip of the each tooth to a base point located between consecutive teeth 140. The range of values for (D3) may be a result of the bores 115 being nonparallel to the first and second gripping surfaces (132, 134). Accordingly, the distance between the bore 115 and the teeth 140 may be a minimum value at the planar surface 117 and a maximum value at the bottom of the bore 115. In some cases, the first and second gripping surfaces (132, 134) may have a length (D1) that is substantially equal to a depth of the bores 115. In some embodiments, the top jaw 106 may be a mirror image of the components of the bottom jaw 108 shown here in FIG. 7. In this regard, the longitudinal centerline 101 may be the line over which the bottom jaw is reflected to depict the top jaw 106.

Of note, the act of creating the bores 115 in the planar surfaces 117 of the top and bottom jaws (106, 108) may reduce the overall structural integrity of the head section 102 of the hand tool 100. Thus, to counteract this reduction and improve the structural integrity of the hand tool 100, and to maintain the grip strength of the top and bottom jaws (106, 108), the top and bottom jaws (106, 108) may include additional material supporting the first and second gripping surfaces (132, 134), respectively. The additional material may account for some of the distance between the teeth 140 and the bore 115 by supporting the first and second gripping surfaces (132, 134) at an angle to the bore 115. In this regard, the top and bottom jaws (106, 108) may be both widened and reinforced.

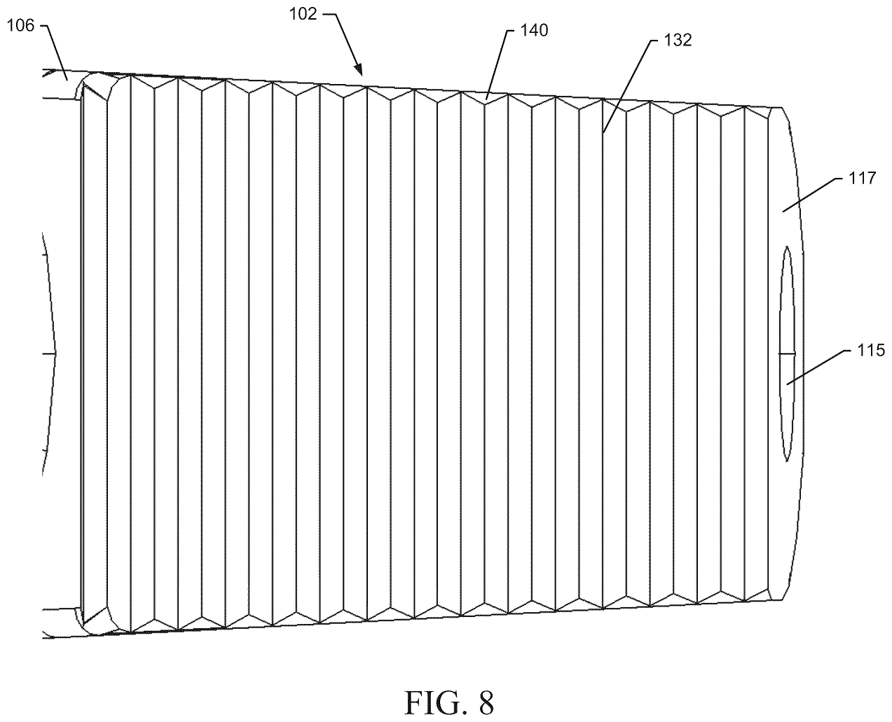

FIG. 8 depicts a close-up, top down view, of the first gripping surface 132 according to an example embodiment. In some cases, the second gripping surface 134 may be visually indiscernible from the first gripping surface 132, the main difference may be that the first gripping surface 132 may be disposed at the top jaw 106 while the second gripping surface 134 may be disposed at the bottom jaw 108. When viewed from above, as depicted in FIG. 8, the first gripping surface 132 may be substantially trapezoidal in shape. In other words, the first gripping surface 132 may include two edges that are parallel to one another, one of which may be longer than the other, and two other edges that are of equal lengths but converge towards one another. In this case, the edge of the first gripping surface 132 that may be disposed most towards the joint assembly 110 may be longer than the edge of the first gripping surface 132 that may be disposed at the distal end of the top jaw 106 proximate to the planar surface 117. The two converging edges may align with the edges of the top jaw 106 and may converge with the taper of the top jaw 106 towards the planar surface 117. In other words, the first and second gripping surfaces (132, 134) may have a smallest width proximate to the distal end of the head section 102. Said smallest width may be approximately equal to two times a diameter of the bore 115. The first and second gripping surfaces (132, 134) may thus also have a largest width at an opposite end of the gripping assembly 130 from the smallest width. Said largest width may be approximately equal to three times a diameter of the bore 115.

Additionally, as a result of the added material supporting the first and second gripping surfaces (132, 134) the first and second gripping surfaces (132, 134) may include a greater contact area at the distal end of each jaw (106, 108). In this regard, the top and bottom jaws (106, 108) may be rounded along a majority of the length of the jaw until the gripping assembly 130. The gripping assembly 130 utilizes the additional material to provide a level contact area for each of the first and second gripping surfaces (132, 134). In other words, without the addition of material to support the gripping assembly 130, the gripping assembly 130 may not be as effective.

Some example embodiments may provide for a hand tool. The hand tool may include a head section which may include a top jaw and a bottom jaw, a handle section which may include a top handle and a bottom handle, a joint assembly which may operably couple the head section to the handle section, a pin assembly which may include a first pin disposed at a distal end of the top jaw and a second pin disposed at a distal end of the bottom jaw, and a gripping assembly which may include a first gripping surface disposed at the top jaw proximate to the first pin and a second gripping surface disposed at the bottom jaw proximate to the second pin. The first and second gripping surfaces may grip objects therebetween responsive to the top jaw and the bottom jaw moving towards each other.

The hand tool of some embodiments may include additional, optional features, and/or the features described above may be modified or augmented. Some examples of modifications, optional features and augmentations are described below. It should be appreciated that the modifications, optional features and augmentations listed below may each be added alone, or they may be added cumulatively in any desirable combination. For example, in some embodiments, the first and second gripping surfaces may extend a distance that may be roughly equal to 10% of a length of the top and bottom jaws, respectively. In some cases, the first and second gripping surfaces may extend from a distal end of the head section towards the joint assembly. In an example embodiment, the first and second gripping surfaces may each comprise teeth. In some cases, the teeth of the first gripping surface may interlace with the teeth of the second gripping surface when the top jaw may be proximate to the bottom jaw. In an example embodiment, a distance between the first and second gripping surfaces and the bores for the first and second pins, respectively, may be within a range of 3 to 4 times a depth of the teeth. In some cases, the first and second pins may be disposed in bores that may be formed in the top and bottom jaws, respectively. In an example embodiment, the first and second gripping surfaces may include a smallest width proximate to the distal end of the head section that may be greater than or approximately equal to two times a diameter of the bores. In some cases, the first and second gripping surfaces may include a largest width at an opposite end of the gripping assembly from the smallest width, that may be approximately equal to three times a diameter of the bores. In an example embodiment, the first and second gripping surfaces may include a length that may be substantially equal to a depth of the bores. In some cases, the hand tool may be a dual function tool that may operably couple with a circlip via the pin assembly and may grip objects with the gripping assembly.

Some example embodiments may provide for a dual function hand tool. The dual function hand tool may include a head section which may include a top jaw and a bottom jaw, a handle section which may include a top handle and a bottom handle, a joint assembly which may operably couple the head section to the handle section, a pin assembly which may include a first pin disposed at a distal end of the top jaw and a second pin disposed at a distal end of the bottom jaw, and a gripping assembly which may include a first gripping surface disposed at the top jaw proximate to the first pin and a second gripping surface disposed at the bottom jaw proximate to the second pin. The dual function hand tool may operably couple with a circlip via the pin assembly and may grip objects with the gripping assembly.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A hand tool comprising:
a head section including a top jaw and a bottom jaw;
a handle section including a top handle and a bottom handle;
a joint assembly operably coupling the head section to the handle section;
a pin assembly having a first pin disposed at a distal end of the top jaw and a second pin disposed at a distal end of the bottom jaw; and
a gripping assembly comprising a first gripping surface disposed at the top jaw proximate to the first pin and a second gripping surface disposed at the bottom jaw proximate to the second pin,
wherein the first and second gripping surfaces grip objects therebetween responsive to the top jaw and the bottom jaw moving towards each other.

2. The hand tool of claim 1, wherein the first and second gripping surfaces extend a distance that is about 10% of a length of the top and bottom jaws, respectively.

3. The hand tool of claim 2, wherein the first and second gripping surfaces extend from the distal end of the top and bottom jaws, respectively, towards the joint assembly.

4. The hand tool of claim 1, wherein the first and second gripping surfaces each comprise teeth,
wherein the teeth of the first gripping surface interlace with the teeth of the second gripping surface when the top jaw is proximate to the bottom jaw.

5. The hand tool of claim 4, wherein the first and second pins are disposed in respective bores formed in the top and bottom jaws, respectively.

6. The hand tool of claim 5, wherein a distance between the first and second gripping surfaces and the bores for the first and second pins, respectively, is within a range of 3 to 4 times a depth of the teeth.

7. The hand tool of claim 5, wherein the first and second gripping surfaces have a smallest width proximate to the distal end of the head section that is greater than two times a diameter of the bores.

8. The hand tool of claim 7, wherein the first and second gripping surfaces have a largest width disposed a length away from a smallest width, that is approximately equal to three times a diameter of the bores.

9. The hand tool of claim 5, wherein a length of the first and second gripping surfaces is substantially equal to a depth of the bores.

10. The hand tool of claim 1, wherein the hand tool is a dual function tool in which a first function comprises operably coupling with a circlip via the pin assembly and a second function comprises gripping an object with the gripping assembly.

11. A dual function hand tool, the dual function hand tool comprising:
a head section including a top jaw and a bottom jaw;
a handle section including a top handle and a bottom handle;
a joint assembly operably coupling the head section to the handle section;
a pin assembly having a first pin disposed at a distal end of the top jaw and a second pin disposed at a distal end of the bottom jaw; and
a gripping assembly comprising a first gripping surface disposed at the top jaw proximate to the first pin and a second gripping surface disposed at the bottom jaw proximate to the second pin,
wherein the dual function hand tool operably couples with a circlip via the pin assembly to define a first function and grips an object with the gripping assembly to define a second function.

12. The dual function hand tool of claim 1, wherein the first and second gripping surfaces extend a distance that is about 10% of a length of the top and bottom jaws, respectively.

13. The dual function hand tool of claim 12, wherein the first and second gripping surfaces extend from the distal end of the top and bottom jaws, respectively, towards the joint assembly.

14. The dual function hand tool of claim 11, wherein the first and second gripping surfaces each comprise teeth.

15. The dual function hand tool of claim 14, wherein the teeth of the first gripping surface interlace with the teeth of the second gripping surface when the top jaw is proximate to the bottom jaw.

16. The dual function hand tool of claim 15, wherein the first and second pins are disposed in bores formed in the top and bottom jaws, respectively.

17. The dual function hand tool of claim 16, wherein a distance between the first and second gripping surfaces and the bores for the first and second pins, respectively, is within a range of 3 to 4 times a depth of the teeth.

18. The dual function hand tool of claim 16, wherein the first and second gripping surfaces have a smallest width proximate to the distal end of the head section that is greater than two times a diameter of the bores.

19. The dual function hand tool of claim 18 wherein the first and second gripping surfaces have a largest width disposed a length away from the smallest width, that is approximately equal to three times a diameter of the bores.

20. The dual function hand tool of claim 19, wherein the length of the first and second gripping surfaces is substantially equal to a depth of the bores.
